(19) United States
(12) Patent Application Publication
(10) Pub. No.: US 2010/0266332 A1
(43) Pub. Date: Oct. 21, 2010

(54) ADAPTER FOR COUPLING A ROD, SUCH AS A LOCKING ROD OF A ROD-TYPE CLOSURE, TO A LEVER, SUCH AS AN ACTUATING LEVER OF THE ROD-TYPE CLOSURE

(76) Inventor: Dieter Ramsauer, Schwelm (DE)

Correspondence Address: FROMMER LAWRENCE & HAUG, 745 FIFTH AVENUE- 10TH FL., NEW YORK, NY, 10151, US

(21) Appl. No.: 12/746,941

(22) PCT Filed: Oct. 23, 2008
(86) PCT No.: PCT/EP08/08957

§ 371 Date: Jun. 23, 2010

(30) Foreign Application Priority Data
Dec. 10, 2007 (DE) 20 2007 017 248.6

(51) Int. Cl. F16D 1/12

(52) U.S. Cl. 403/155

(57) ABSTRACT

An adapter for the articulation of a bar (such as a lock bar of a bar closure) at a lever (such as an actuating lever of the bar closure), including a connection piece with an articulation eyelet at one end and a receiving cavity for the end of the bar at the other end. A clamping device, which extends into the cavity, secures the bar in the cavity. The articulation eyelet has a bore hole for forming a securing device, by which the adapter is fitted to a joint bolt which is carried by the drive lever. The joint bolt has an annular groove and is secured either by a retaining ring in the annular groove or, alternatively, by springing tongues proceeding from an edge of the bore hole, these springing tongues being supported in the annular groove of the joint bolt.

The present application claims priority from PCT Patent Application No. PCT/EP2008/008957 filed on Oct. 23, 2008, which claims priority from German Patent Application No. DE 20 2007 017 248.6 filed on Dec. 10, 2007, the disclosure of which is incorporated herein by reference in its entirety.

### BACKGROUND OF THE INVENTION

1. Field of the Invention

The invention is directed to an adapter for the articulation of a rod or bar, such as a lock bar of a bar closure, at a lever, such as an actuating lever of the bar closure, comprising a connection piece with an articulation eyelet with a securing device at one end and a receiving cavity for the end of the bar at the other end, wherein a clamping device extending into the cavity is provided for securing the end of the bar.

2. Description of Related Art

An adapter device of the type mentioned above for a round bar is already known from page 1-170 of the complete catalog, print data 05/94/3, by DIRAK GmbH & Co. K G, Königsfelder Str. 1, 58256 Ennepetal. The advantage of adapters of this kind consists in that the bar can be shortened as desired because the end of the bar itself does not require any special machining to be guided through a hole, for example, so that an articulation can be carried out.

In the prior art, the clamping device comprises a set screw which clamps the end of the bar when screwed in. However, a screw can loosen, thereby defeating the clamping effect so that the bar may fall down and the door can no longer be opened. Further, there is the risk that a screw of this kind can be lost, for example, it may fall inside a switch cabinet and cause malfunctions through short circuiting.

The eyelet also has means for preventing a joint pin from sliding down, which offers different possibilities for fastening.

### SUMMARY OF THE INVENTION

It is the object of the invention to provide an alternative securing device for the adapter.

In a particularly advantageous solution for forming the securing device, the eyelet has a bore hole by which the adapter is fitted to a bolt which is carried by the drive lever and which has an annular groove and is secured by a retaining ring in the annular groove or, alternatively, in that the bore hole forms or has an edge and springing tongues proceeding from the edge. These tongues are supported on the annular groove which is formed by a joint bolt carried by the drive lever and, alternatively, can also serve to receive the retaining ring.

According to a further development, the springing tongues proceeding from the edge at one end of the bore hole of the eyelet are guided through the bore hole of the eyelet, which provides a larger lever arm for the tongue and increases its spring characteristics.

According to another further development, the bore hole of the eyelet is widened in the area of the free ends of the springing tongue to afford the springing tongues possibilities to expand.

The springing tongues can also be formed by a metal sleeve, one of whose front edges has a plurality of notches to form the tongues.

Alternatively, the eyelet is made from injection molded plastic and the springing tongues can proceed from the eyelet integral therewith.

According to another embodiment form, the cavity is advantageously suited to receive the free end of a bar which can be inserted therein, this bar being provided at its end with an opening or recess, and a spring leg projecting into the cavity can be received in the opening or recess so as to lock the bar.

In a possible embodiment form, a bar has a rectangular profile at least at the end that is to be received by the adapter.

Alternatively, the bar can also have a round profile at least at the end that is to be received by the adapter.

The clamping device can be formed by a disk spring which is inserted laterally into a slot traversing the receiving cavity.

The end of the bar can have a round cross section and the disk spring has an opening which is adapted to it and which is provided with sharp edges and, inasmuch, has edges which contact the bar surface at an inclination so that it is possible for the end of the bar to be inserted into the cavity, but not be pulled out of the cavity.

The bar receptacle part is advantageously made from injection molded plastic, which plastic flows around the flat spring disk which is held in this way.

### BRIEF DESCRIPTION OF THE DRAWINGS

FIG. 1A shows a top view;

FIG. 1B shows an axial sectional view;

FIG. 1C shows an exploded, perspective view;

FIG. 1D shows a perspective view of a first embodiment form of an assembled adapter which connects a round bar to a lever;

FIGS. 2A, 2B, 2C and 2D show analogous views of an embodiment form in which the provided adapter has a securing device which makes do without a securing disk;

FIGS. 3A, 3B, 3C and 3D show corresponding views of an adapter for a flat strip bar;

FIG. 3E shows a view which is rotated by 90 degrees; and

FIG. 3F shows an axial sectional view, likewise rotated by 90 degrees, of the adapter device for a rectangular bar.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

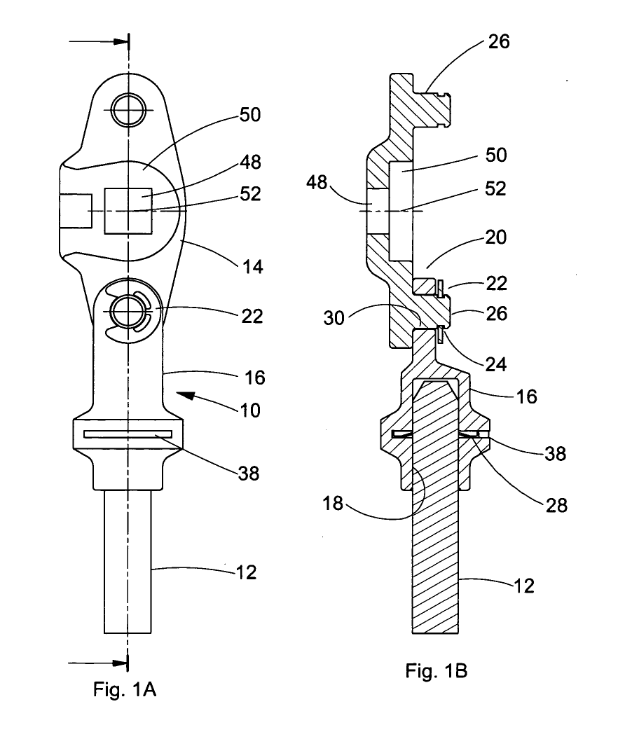

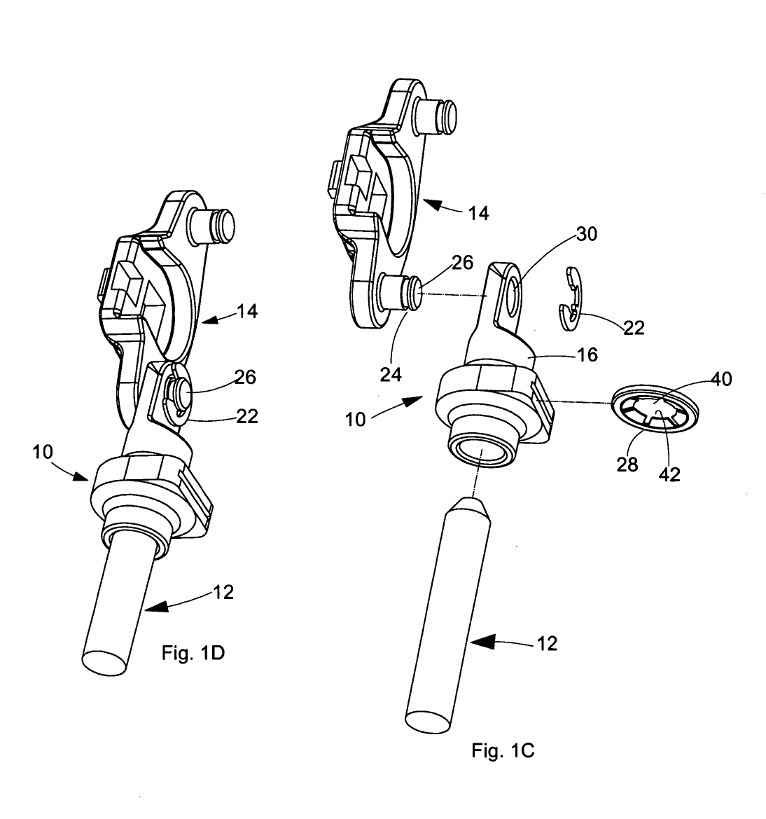

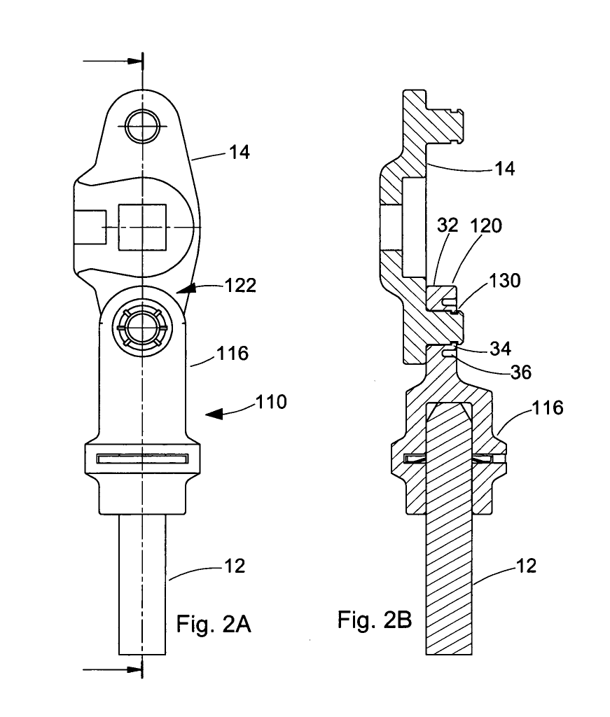

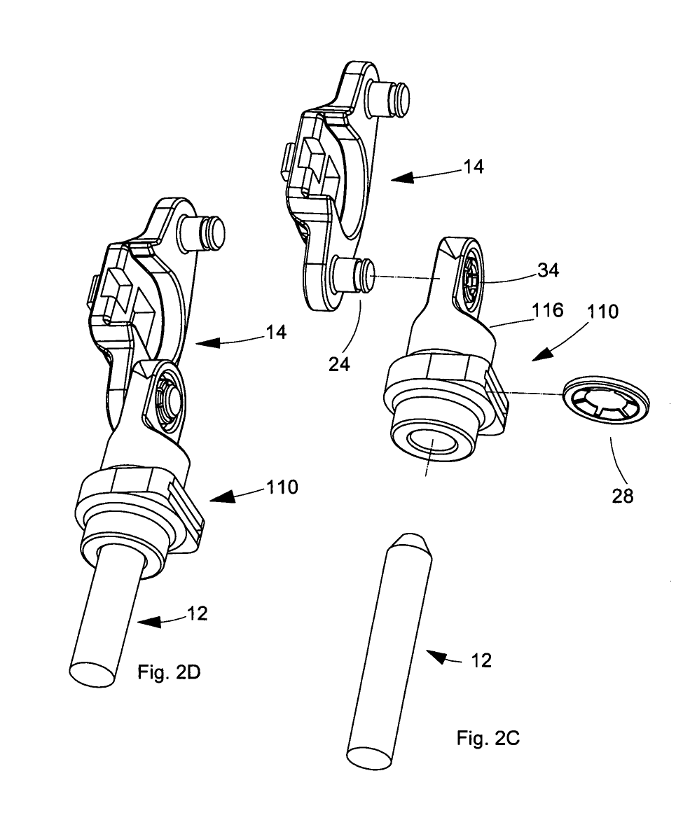

FIG. 1A is a top view showing an adapter 10 for the articulation of a bar 12 such as a locking bar of a bar closure, not shown, at a lever 14, such as an actuating lever of the bar closure, comprising a connection piece 16 with an articulation eyelet 20 having a securing device 22 at one end and a receiving cavity 18 for the end of the bar 12 at the other end (see also FIGS. 1B, 1C and 1D). A clamping device 28 extending into the cavity 18 is provided for securing the bar end 12. To form the securing device 22, the articulation eyelet 20 has a bore hole 30 through which the joint bolt 26 can be inserted in such a way that the eyelet 20 is prevented from sliding off by means of a retaining ring 22 inserted into the groove 24. In the embodiment form according to FIGS. 2A to 2F, the bore hole 130 has an edge 32 from which springing tongues 34 project. The springing tongues 34 are supported in the annular groove 24 formed by the joint bolt 26 which is supported by the drive lever 14. In order to limit the movement of the tongues, it is advantageous in the embodiment form according to FIGS. 2A and 2B when springing tongues proceeding from the edge at one end of the bore hole of the eyelet are guided through the bore hole 130 of the eyelet 20 as can clearly be seen from FIG. 2B. In addition, the bore hole of the eyelet (see reference number 36) is widened in the area of the ends of the springs 34 to provide the springing tongues 34 with room for expanding.

Alternatively, not shown, the springing tongues 34 can be formed by a metal sleeve, one of whose front edges has a plurality of notches so as to form the tongues as in the embodiment form shown in FIGS. 2A and 2B. For adapters for round bars, it is advantageous when the clamping device 28 is formed by a disk spring which is inserted laterally into a slot 38 traversing the receiving cavity. This embodiment form is provided in all adapters designed for a round bar.

In this connection, the end of the bar is provided with its round cross section and the disk spring 28 is provided with an opening 40 adapted to the latter in such a way that its edges 42 are sharp such that they contact the bar surface at an inclination so that the end of the bar can be inserted into the cavity 18, but cannot be pulled out of the cavity 18.

The bar receptacle part of the adapter 16, or the entire adapter, can be made of injection molded plastic, this plastic flowing around the flat spring disk 28 so that the flat spring disk 28 is held and cannot slip out. However, this can also be achieved in that the spring catches in the slot 38 when inserted.

The adapter makes it possible to secure an unmachined, shortened end of the bar 12 with the sharp-edged spring 28 and, in this way, to hold the end of the bar 12 in the eyelet 20 fitted to the joint bolt 26 in an articulated manner and so as to be secured by a retaining disk 22 or by springing tongues 34, wherein the bar 12 is displaced by rotating the lever 14 which can also have a tongue, not shown.

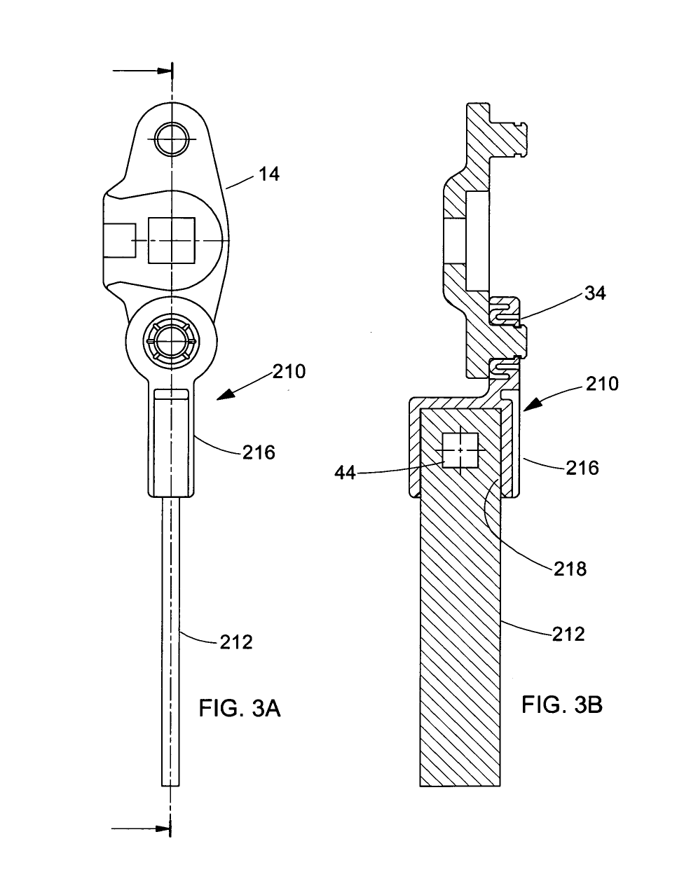

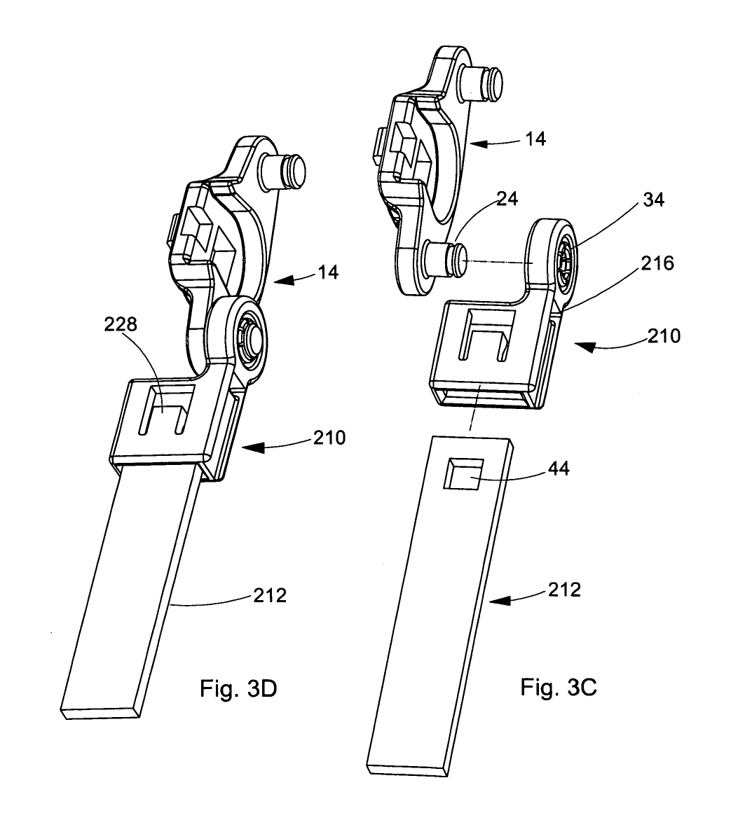

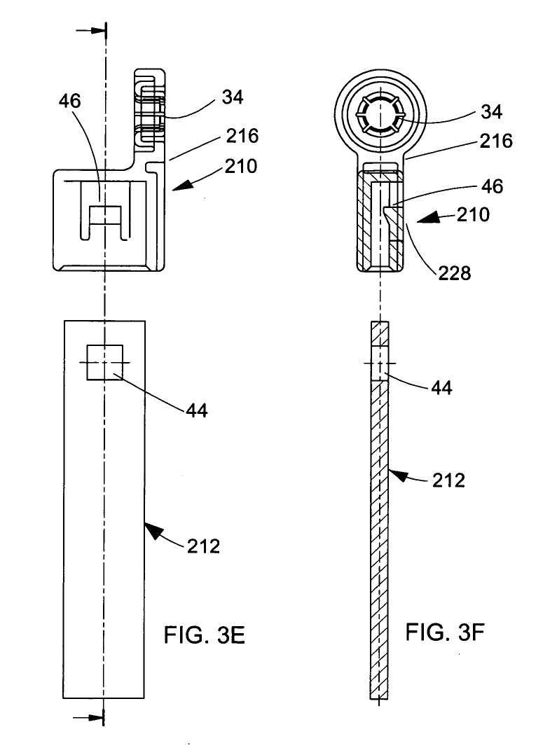

FIGS. 3A to 3F show that the cavity can be shaped in such a way that the end of the bar can be inserted into the adapter, the bar 212 being provided with an opening 44 or recess at its end suitable for carrying out the invention. A spring leg 46 projecting into a cavity 218 can be received in the opening or recess 4 in a locking manner. In this way, the end of the bar 212 is held in the receptacle 218. The bar 212 can be a round bar, but a flat strip bar which is particularly suitable for this embodiment form is provided in this case.

In the three embodiment forms described herein, the lever 14 is an actuating lever, a joint bolt 26 with an annular groove 24 being arranged at its two ends. The lever 14 has a square opening 48 in the middle between these joint bolts 26 for receiving a lever drive, not shown, which is formed by a square. The lever also has a receiving space 50 for supporting an optional sash-type fastener tongue, not shown, in a recessed manner and so as to be rigid against rotation. The recessing serves to ensure that the lever 14 and adapter 10 can be swiveled relative to one another by 90 degrees at least twice, the rotational movement of the lever 14 around its axis of rotation 52 being transformed into a substantially longitudinally axial forward feed movement of the bar 12.

### COMMERCIAL APPLICABILITY

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

10, 110, 210 adapter for round bar

12, 212 bar

14 lever

16, 116, 216 connection piece

18, 218 receptacle, cavity

20, 120 articulation eyelet

22, 122 securing device, retaining disk, springing tongue

24 annular groove

26 joint bolt

28, 228 clamping device, spring disk, tongue

30, 130 bore hole

32 edge

34 springing tongue

36 widening of the bore hole

38 slot

40 opening

42 edges

44 opening

46 tongue

48 opening

50 receiving space

52 axis

1. An adapter for the articulation of a bar at a lever, comprising:
a connection piece with two ends, one of the two ends having an articulation eyelet with a securing device and the other of the two ends having a receiving cavity for an end of the bar;
a clamping device which extends into the cavity, the clamping device being provided for securing the end of the bar in the cavity;
wherein the articulation eyelet has a bore hole for forming the securing device, the adapter being fitted, via the bore hole, to a joint bolt which is carried by the drive lever; and
wherein the joint bolt has an annular groove and is secured either:
by a retaining ring in the annular groove;
by springing tongues proceeding from an edge of the bore hole, the springing tongues being supported in the annular groove of the joint bolt.

2. The adapter according to claim 1;
wherein the springing tongues proceeding from the edge at one end of the bore hole of the eyelet are guided through the bore hole of the eyelet.

3. The adapter according to claim 2;
wherein the bore hole of the eyelet is widened in the area of the free ends of the springing tongues to provide the springing tongues with room to expand.

4. The adapter according to claim 1;
wherein the springing tongues are formed by a metal sleeve, one of front edges of the metal sleeve having a plurality of notches to form the tongues.

5. The adapter according to claim 1;
wherein the eyelet is made from injection molded plastic and the springing tongues proceed from the eyelet integral therewith.

6. The adapter according to claim 1;
wherein the end of the bar which is to be received in the receiving cavity of the connection piece has an opening or recess; and
wherein a spring leg projecting of the adapter projects into the cavity and can be received in the opening or recess so as to lock the bar.

7. The adapter according to claim 6;
wherein the bar has a rectangular profile at least at the end to be received by the adapter.

8. The adapter according to claim 6; wherein the bar has a round profile at least at the end to be received by the adapter.

9. The adapter according to claim 1;
wherein the clamping device is formed by a disk spring which is inserted laterally into a slot traversing the receiving cavity.

10. The adapter according to claim 9;
wherein the end of the bar has a round cross section and the disk spring has an opening which is adapted to the end of the bar, the disk spring having has sharp edges which contact the bar surface at an inclination such that it is possible for the end of the bar to be inserted into the cavity, but the end of the bar cannot be pulled out of the cavity.

11. The adapter according to claim 10;
wherein the part of the adapter for receiving the bar is made from injection molded plastic, the plastic flowing around the flat spring disk which is held in this way.
